(19) United States
(12) Patent Application Publication
(10) Pub. No.: US 2013/0319759 A1
(43) Pub. Date: Dec. 5, 2013

(54) FINE-PITCH FLEXIBLE WIRING

(71) Applicants: James Wilson Rose, Guilderland, NY (US); Kaustubh Ravindra Nagarkar, Clifton Park, NY (US); Craig Patrick Galligan, Niskayuna, NY (US); Binoy Milan Shah, Schenectady, NY (US); Oliver Richard Astley, Clifton Park, NY (US)

(72) Inventors: James Wilson Rose, Guilderland, NY (US); Kaustubh Ravindra Nagarkar, Clifton Park, NY (US); Craig Patrick Galligan, Niskayuna, NY (US); Binoy Milan Shah, Schenectady, NY (US); Oliver Richard Astley, Clifton Park, NY (US)

(73) Assignee: GENERAL ELECTRIC COMPANY, Schenectady, NY (US)

(21) Appl. No.: 13/485,526

(22) Filed: May 31, 2012

(51) Int. Cl. H02G 15/02; H01B 13/00

(52) U.S. Cl. 174/74 R; 156/47

(57) ABSTRACT

A flexible wire assembly includes a plurality of elongated conductors and insulators each having a quadrilateral cross section and alternatingly laminated together, the flexible wire assembly having a wire width measured across the conductor and insulators, a wire height equivalent to the height of the conductors and insulators, and a wire length which is measured in a longitudinal direction orthogonal to the wire width and the wire height, wherein the wire length is one or more orders of magnitude greater than the wire width and the wire height; and a first device comprising a plurality of bond pads spaced to define a bond pad pitch, wherein the flexible wire assembly is coupled to the first device at the bond pads such that spacing of the conductor conductors is matched to the bond pad pitch.

### BACKGROUND

With the continued advancement of integrated circuit (IC) technologies, the size of the transistors used to form the ICs has decreased dramatically. This has allowed engineers and designers to increase the processing power of the ICs while keeping the same footprint, or to decrease the footprint of the ICs themselves. The decrease in IC size has continued to drive new development and open new application space. Unfortunately, however, it is frequently the IC packaging and wiring interconnects that have become the limiting factor in miniaturization.

Although the fabrication of multi-lead flexible cables has helped alleviate some of these wiring challenges, known techniques are becoming increasingly difficult and expensive to employ as the geometry of the leads are forced to decrease. Moreover, single wires typically have a large form-factor, are difficult to align and connect, and they require multiple steps including wire bonding and hand soldering to meet the pad pitch of the package. For example, FIG. 1 illustrates a conventional IC system 1 including an IC fabricated on a die 6 mounted on a site 4 that is patterned on a substrate 2. The die 6 is wired to the substrate 2 via leads 8 that electrically couple bond pads on the die to the traces 7 patterned on the substrate 2. Wires 9 are manually bonded to each of the traces 7 to provide routing of electrical signals on and off of the substrate 2 and ultimately to and from the IC. It should be appreciated that not only does the manual bonding of the wires 9 require increased time and skill, as the size of package 2 decreases, the likelihood of an electrical short or physical entanglement developing between wires 9 also increases due to their unrestrained nature. Moreover, the additional structure between the wires 9 and die 6 add undesirable cost and complexity to the overall system and render further downscaling difficult. It should also be appreciated that the size of the substrate 2 and traces 7 is substantially larger than the size of the die 6 and leads 8 in order to facilitate manual bonding of the wires 9 to the traces 7.

Although there has been some limited work performed in the area of fine-pitch connectors, these solutions are typically designed around bulk z-axis conductors such as interposers or rubber compression connectors. For example, U.S. Pat. No. 6,581,276 describes a fine-pitch connector that is formed by interleaving layers of conductors and insulators to form a stack. The stack is then sliced in a direction transverse to an elongated direction of the conductors to make a plurality of stack slices. The stack slices are then stacked on top of one another to form a plurality of greater stacks. The greater stacks are then interleaved side-by-side with dielectric and are further laminated to form the connector. Although this bulk connector structure may be useful for interposer type applications where the conduction occurs in the z-direction, these solutions do nothing to address the need for miniaturized wiring to carry signals over long distances.

Ribbon cables or bonded wires allow an easier attachment mechanism, but are too large for the application to ICs. In ribbon cables or bonded wires, each wire is separately insulated before being joined together. During fabrication, a number of spools of wire are each separately coated with an insulator. Momentarily after the insulator coating, the insulated wires are bonded together as the coating sets up. Unfortunately, this method is not scalable to the IC level as discrete wires become more difficult to handle as their size decreases resulting in uncontrolled wire-pitch.

Therefore there is a need for an improved flexible wiring assembly to address the limitations set forth above.

### BRIEF DESCRIPTION

In accordance with one embodiment a method of making a flexible wire assembly is provided. The method comprises forming a laminate stack of alternating parallel layers of conducting material and insulating material, wherein the layers of conducting material and the layers of insulating material are substantially planar, and wherein the laminate stack is defined by a stack width (SW) dimension, a stack length (SL) dimension, and a stack height (SH) dimension, and wherein the stack width (SW) and the stack length (SL) dimensions are coplanar with the conducting and insulating layers and the stack height (SH) dimension is measured transversely across the conducting and insulating layers; and singulating the laminate stack into at least one long flexible wire assembly having alternating conductors and insulators by dicing the laminate stack at a singulation pitch along a longitudinal axis aligned with the stack length (SL) such that the resulting flexible wire assembly comprises a wire length (wl), a wire width (ww) and a wire height (wh), wherein the wire width (ww) corresponds to the stack height (SH), the wire height (wh) corresponds to the singulation pitch, and the wire length (wl) corresponds to the stack length (SL) and is one or more orders of magnitude greater than the wire width (ww) and the wire height (wh).

In accordance with another embodiment, a flexible wiring system is provided. The flexible wiring system comprises a flexible wire assembly comprising a plurality of elongated conductors and insulators each having a quadrilateral cross section and alternatingly laminated together, the flexible wire assembly having a wire width (ww) measured across the conductor and insulators, a wire height (wh) equivalent to the height of the conductors and insulators, and a wire length (wl) which is measured in a longitudinal direction orthogonal to the wire width and the wire height, wherein the wire length is one or more orders of magnitude greater than the wire width (ww) and the wire height (wh); and a first device comprising a plurality of bond pads spaced to define a bond pad pitch, wherein the flexible wire assembly is coupled to the first device at the bond pads such that spacing of the conductor conductors is matched to the bond pad pitch.

### DRAWINGS

These and other features, aspects, and advantages of the present invention will become better understood when the following detailed description is read with reference to the accompanying drawings in which like characters represent like parts throughout the drawings, wherein:

FIG. 1 illustrates a conventional IC system.

FIG. 2 is a schematic diagram illustrating a laminate stack in accordance with one embodiment of the invention.

FIG. 3 is a schematic diagram illustrating singulation of the laminate stack 10 of FIG. 2, in accordance with one embodiment.

FIG. 4 is a schematic diagram illustrating one embodiment of a flexible wiring system including the flexible wire assembly coupled to a device.

FIG. 5 illustrates a variety of embodiments of a flexible wiring system including the flexible wire assembly coupled to a device.

FIG. 6 illustrates a flexible wire assembly in a twisted configuration according to one embodiment of the invention.

FIG. 7 illustrates a flexible wire assembly in the form of a flexible instrument assembly, in accordance with a further embodiment of the invention.

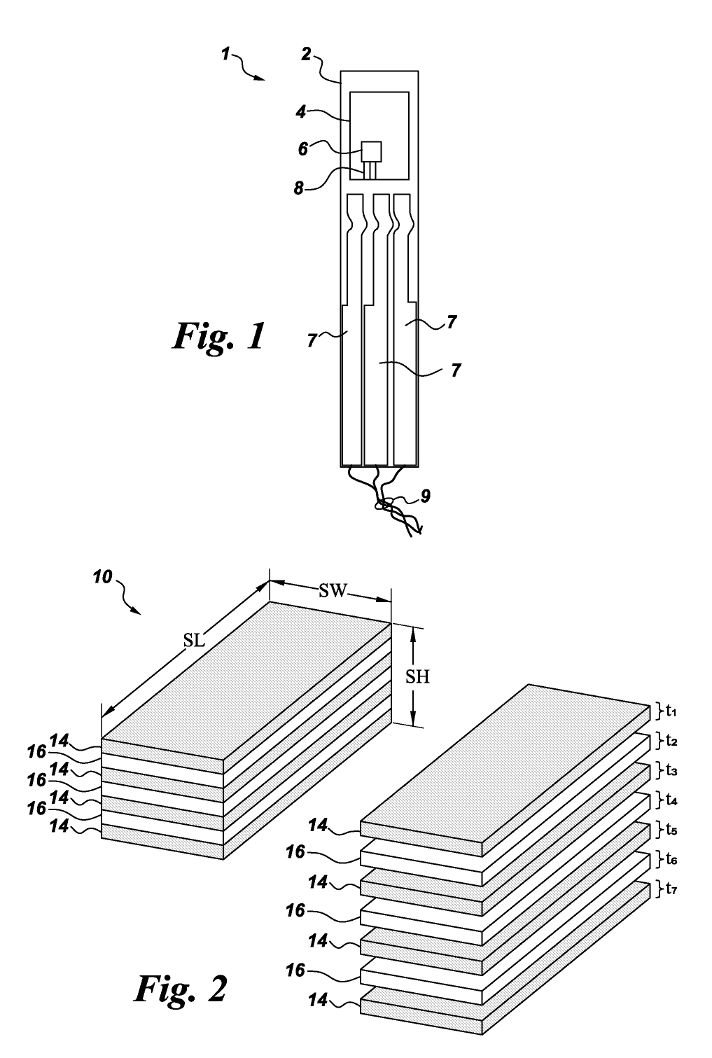

### DETAILED DESCRIPTION

In the following detailed description, numerous specific details are set forth in order to provide a thorough understanding of various embodiments of the present invention. However, those skilled in the art will understand that embodiments of the present invention may be practiced without these specific details, that the present invention is not limited to the depicted embodiments, and that the present invention may be practiced in a variety of alternative embodiments. In other instances, well known methods, procedures, and components have not been described in detail.

Furthermore, various operations may be described as multiple discrete steps performed in a manner that is helpful for understanding embodiments of the present invention. However, the order of description should not be construed as to imply that these operations need be performed in the order they are presented, nor that they are even order dependent. Moreover, repeated usage of the phrase “in one embodiment” does not necessarily refer to the same embodiment, although it may. Lastly, the terms “comprising”, “including”, “having”, and the like, as well as their inflected forms as used in the present application, are intended to be synonymous unless otherwise indicated.

In accordance with one embodiment of the invention, a laminate stack of alternating parallel layers of conducting material and insulating material is formed. The laminate stack is then singulated by dicing the laminate stack along a longitudinal axis into at least one long flexible wire assembly having alternating conductors and insulators. The resulting flexible wire assembly and the related methods described herein provide a cost-effective, reproducible and scalable flexible wiring solution that solves the problems recognized in the prior art.

FIG. 2 is a schematic diagram illustrating a laminate stack in accordance with one embodiment of the invention. In FIG. 2, parallel layers of insulating material (hereinafter insulating layers 14) and layers of conducting material (hereinafter conducting layers 16) are shown as being substantially planar and having a thickness (t1-t7). FIG. 2 further illustrates a laminate stack 10 formed from the alternating insulating layers 14 and conducting layers 16. The thicknesses t of each of the insulating layers 14 may be the same throughout the laminate stack 10, or the thicknesses t of each of the insulating layers 14 may differ from one another (e.g., t1=t3=t5, t1=t3≠5, t1≠t3=t5, or t1≠t3≠5) depending upon the separation desired between the conducting layers in the resulting flexible wire assembly to be described further herein. Similarly, the thicknesses t of each of the conducting layers 16 may be the same throughout the laminate stack 10, or the thicknesses t of each of the conducting layers 16 may differ (e.g., t2=t4=t6, t2=t4≠t6, t2≠t4=t6, or t2≠t4≠6) depending upon the width of the conductors desired in the resulting flexible wire assembly. Furthermore, the thicknesses t of one or more insulating layers 14 may be the same or different from one or more conducting layers 16 (e.g., t1=t2=t3, t1=t2≠t3, t1≠t2=t3, or t1≠t2≠t3).

In accordance with one embodiment, the laminate stack 10 may be formed by alternatingly layering insulating material and conducting material to form a three-dimensional stack in the x, y and z directions. The insulating material and conducting material may be layered in a variety of manners including, but not limited to deposition, spray coating or through the placement of unitary sheets of material on top of one another. One or more of the insulating materials may comprise flexible electrically insulating materials including but not limited to polyimide, polyester, silicone, PTFE, polyacrylate, or flexible borosilicate glass. In one embodiment, the insulating materials may comprise a polyimide material such as KAPTON® or PYRALUX® both available from DuPont™. One or more of the layers of conducting materials may include conductive materials such as metals including but not limited to gold, platinum, silver, copper, tin, lead, zinc, aluminum and alloys thereof. Conducting materials may also include nonmetals such as graphene and carbon nanotubes or nanorods. In one embodiment an adhesive is provided at each interface between an insulating layer 14 and a conducting layer 16. The provision of the adhesive may comprise a separate deposition or layering step or the adhesive may be included as part of the insulating material or the conducting material. For example, the insulating material may comprise an acrylic based laminate sheet adhesive such as Pyralux® LF overlaid on the insulating material. Moreover, in alternative embodiments, the insulating layers 14 and conducting layers 16 may be laminated in the absence of an adhesive.

Each of the constituent insulating layers 14 and conducting layers 16 in the stack need not be placed in the stack separately, but may be first pre-combined into a unitary layer which is then provided as part of the stack to be laminated. In such a case, however, the insulating and conducting functionality of such a combined layer is nonetheless retained when placed in the stack. For example, the insulating material may comprise an all polyimide laminate constructed of polyimide film laminated to a layer of copper on a single side (e.g., Pyralux® AC) or an all polyimide laminate constructed of polyimide film laminated to a layer of copper on two sides (e.g., Pyralux® AP). Additionally, two or more layers of insulating material or two or more layers of conducting material may be combined to respectively form a single insulating layer 14 or a single conducting layer 16. Moreover, in accordance with embodiments of the invention, the conducting layers need not be patterned nor etched, thus saving time and process complexity as compared to conventional processes.

Once the constituent insulating layers 14 and conducting layers 16 are stacked, heat and pressure are applied to form the laminate stack 10. In one embodiment, the alternating layers are inserted into a press and a pressure of approximately 20,000 psi is applied over a temperature range of 50-230 degrees C. If necessary, the edges of the resulting laminate stack 10 may be trimmed or otherwise cleaned to form clean and regular edges.

In one embodiment, the laminate stack 10 resembles a rectangular prism or right rectangular prism and, for the ease of description, can be defined as having a stack width (SW) and a stack length (SL) as illustrated in FIG. 2. The stack width (SW) and stack length (SL) represent coplanar dimensions that respectively correspond to the width and length of each constituent insulating layer 14 or conducting layer 16. The stack width (SW) may be considered to correspond to the x-axis and the stack length (SL) may be considered to correspond to the y-axis. Accordingly, in the illustrated example, each of the insulating layers 14 and conducting layers 16 would lie in the x-y plane. Additionally, the laminate stack 10 can further be defined as having a stack height (SH) that is measured across the insulating layers 14 and the conducting layers 16 in the z-direction orthogonal to the x-y plane. In various embodiments, the stack length (SL) will be much longer than the stack width (SW) and the stack height (SH).

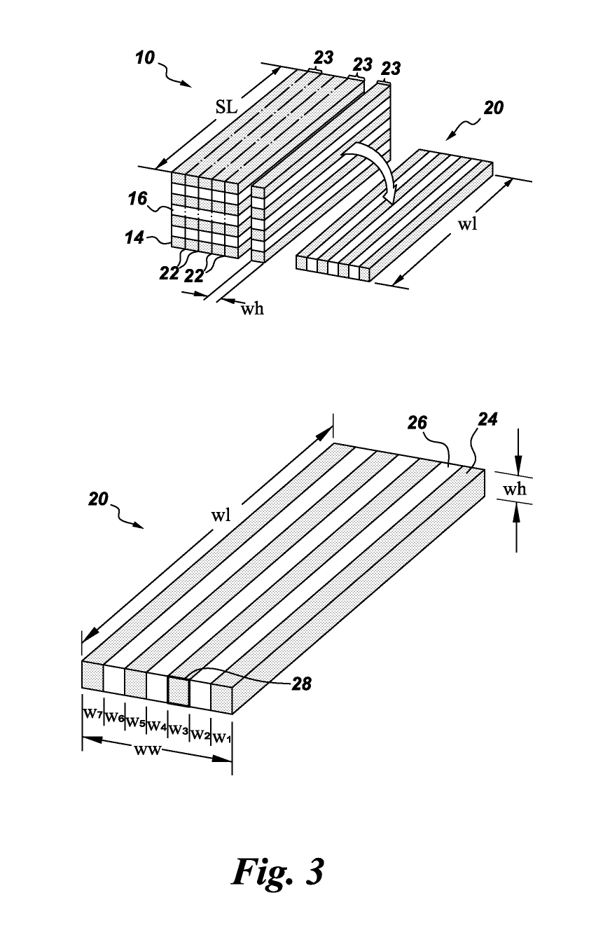

In accordance with one embodiment, once formed, the laminate stack 10 is singulated to form one or more flexible wire assemblies. FIG. 3 is a schematic diagram illustrating singulation of the laminate stack 10 into at least one flexible wire assembly 20 comprising a plurality of alternating elongated insulators 24 and elongated conductors 26, in accordance with one embodiment. In the illustrated embodiment, the laminate stack 10 is singulated along a longitudinal axis 22 aligned with and parallel to the stack length dimension (SL). In accordance with embodiments herein, the term singulating or singulation is used to describe the process of separating or dicing one or more flexible wire assemblies from the laminated stack of insulating layers and conducting layers. In various embodiments, the laminate stack may be singulated through a mechanical process, such as sawing, cutting, rapid shearing or breaking, or the laminate stack 10 may be singulated through an ablative process, such as that produced by a laser. In a specific embodiment, the laminate stack 10 may be singulated using a Thermocarbon Tcar864-1 dicing saw & wafer saw. Other cutting techniques such as roll-to-roll feeding of the laminate stack or parallel tools can be used to accelerate the singulation process.

The laminate stack 10 may be singulated according to a singulation pitch 23, which may remain constant or may vary across the stack width (SW) of the laminate stack 10, depending upon the specific application. In one embodiment, the singulation pitch 23 is less than 200 μm. Once singulated, the resulting flexible wire assembly 20 can be said to have a wire width (ww) corresponding to the stack height (SH), where the thickness tₙ of each insulating and conducting layer (14, 16) corresponds to the respective widths wₙ of the elongated insulators 24 and elongated conductors 26. Although in the illustrated embodiment, the flexible wire assembly 20 comprises four elongated insulators 24 and three elongated conductors 26, any number of insulators and conductors can be constructed by varying the number of insulating layers 14 and conducting layers 16 of the laminate stack 10. As with the thicknesses t of the insulating and conducting layers, the widths wₙ of the elongated insulators 24 and elongated conductors 26 may differ from one another or they may be the same across the width of the flexible wire assembly 20. In one embodiment, the elongated insulators 24 and elongated conductors 26 have a quadrilateral or non-circular cross-section 28 as viewed with respect to a plane orthogonal to both the longitudinal axis 22 and the insulating layers 14 and conducting layers 16. The flexible wire assembly 20 can be said to further have a wire length (wl) corresponding to the stack length (SL), and a wire height (wh) corresponding to the singulation pitch 23. In one embodiment, the wire length (wl) is at least one order of magnitude greater than the wire width (ww) and wire height (wh). In a specific example, the wire length (wl) is multiple orders of magnitude greater than the wire width (ww) and the wire height (wh). In one specific example, the wire height (wh) of the flexible wire assembly 20 is less than 200 μm while the wire length (wl) is approximately 1 m. However, in accordance with the teachings of the invention the wire length can extend up to and beyond multiple meters in length depending upon the intended application. Due to the high ratio of wire length to wire height (or wire width), the flexible wire assembly 20 can achieve great flexibility. Moreover, the wire length (wl) can be extended up to many meters in order to obtain very long, fine-pitched, flexible wiring assemblies that can be utilized in a wide variety of applications where such long, fine-pitched, flexible wiring may be beneficial.

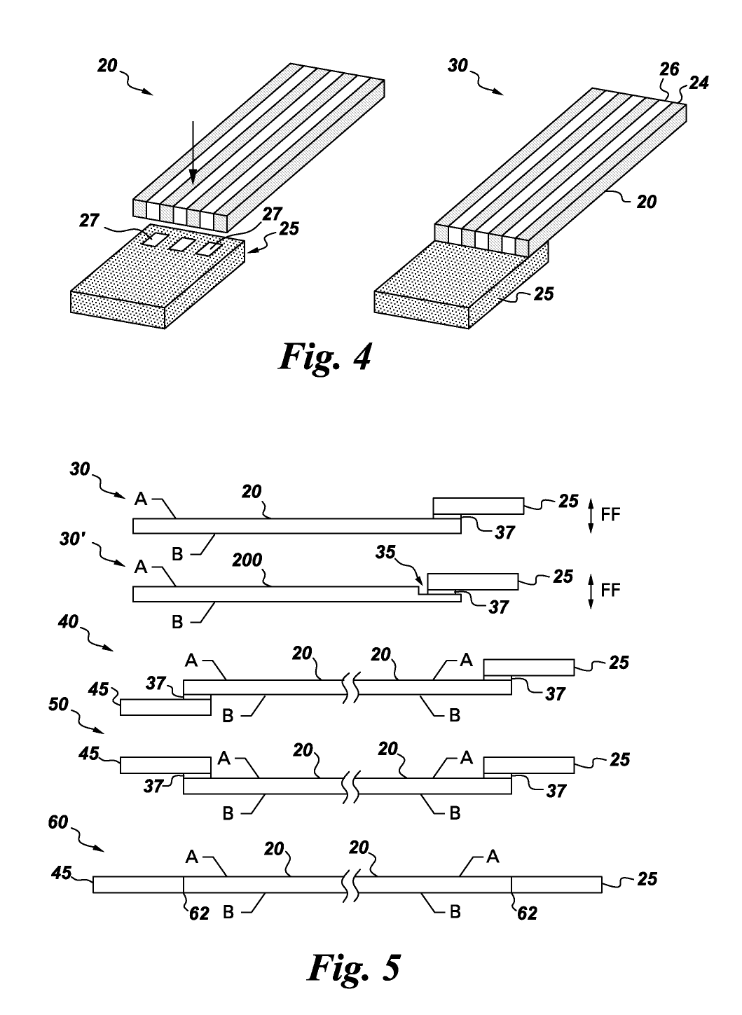

FIG. 4 is a schematic diagram illustrating one embodiment of a flexible wiring system 30 including the previously described flexible wire assembly 20 coupled to a device 25. In accordance with various embodiments of the invention, the device 25 may generically represent an integrated circuit, a semiconductor, power electronics, a die, a package, a connector or any other electrical, mechanical or structural device, for example. In the illustrated embodiment, the device 25 represents a semiconductor die having interconnects 27. In accordance with one embodiment, the interconnects 27 represent bond pads. The flexible wire assembly 20 is coupled to the device 25 such that the spacing between the elongated conductors 26 matches the spacing between the interconnects 27. In one embodiment, the respective thicknesses of the insulating layers 14 and conducting layers 16 of the flexible wire assembly 20 are specifically chosen to correspond to the spacing between the interconnects 27 of the device 25. The flexible wire assembly 20 may be coupled to the device 25 in a variety of ways. In a non-limiting example, the flexible wire assembly may be laid within a channel of a holder or fixture, while a pick and place machine places the die on the flexible wire assembly 20, for example. Alternatively, the device 25 could be held stationary while the flexible wire assembly 20 is positioned over the device. In one embodiment, a layer of anisotropic conductive film may be overlaid on the flexible wire assembly 20, the anisotropic conductive film may be heated to pre-tack the film and the device 25 may then be placed on the flexible wire assembly 20 over the anisotropic conductive film. In other embodiments, other bonding methods could be used to attach the flexible wire assembly 20 to the device 25 including, without limitation, solder attach, non-conductive adhesive compressive displacement techniques; ultrasonic, thermosonic, or thermocompression solid state diffusion joining techniques; conductive epoxy joining whether by film, paste, or liquid; and by using anisotropic conductive paste (ACP). In one embodiment, a non-conductive adhesive or insulating coating is applied over the die and flexible wire assembly 20 to add mechanical strength and/or electrical isolation to the system. The coating may be applied through a rapid dip-coating process or through the application of a separate laminate material. Additionally, the coating may comprise high-temperature resistant materials to further use in high-temperature environments.

FIG. 5 illustrates a variety of embodiments of a flexible wiring system including the flexible wire assembly 20 coupled to the device 25. As previously described, in the flexible wiring system 30, the flexible wire assembly 20 may be coupled to the device 25 by way of interconnects 27, such as a bond pads. The device may be further coupled using a bonding material 37, such as anisotropic conductive film or paste, solder or any other method known to bond conductors such as those previously described with respect to FIG. 4. The flexible wiring system 30′ is substantially similar to the flexible wiring system 30 except a cut-out 35 has been made in the flexible wire assembly 200. The cut out can be made in a number of ways such as through mechanical grinding, thermal ablation, chemical etching and so forth. The cut out allows for a decreased overall form-factor (FF) for the flexible wiring system 30′ as compared to that of flexible wiring system 30. Moreover, the cut out 35 or similar end treatment can be made on the matching end of two flexible wire assemblies such that the flexible wire assemblies may be spliced together to even further extend the length of the flexible wire assembly after singulation.

Flexible wiring system 40 includes a flexible wire assembly 20 coupled to two devices (25, 45). In the illustrated embodiment, the first device 25 is coupled to a first (e.g., top) side A of the flexible wire assembly 20, whereas the second device 45 is coupled to a second (e.g., bottom) side B of the flexible wire assembly 20. Similarly, the flexible wiring system 50 includes a flexible wire assembly 20 coupled to two devices (25, 45), however, each device is coupled to the same side (e.g., side A) of the flexible wire assembly 20. In each of flexible wiring system 40 and flexible wiring system 50, the flexible wire assembly 20 is shown in broken form to illustrate the long length of the flexible wire assembly. Lastly, with flexible wiring system 60, the flexible wire assembly 20 is coupled between the first device 25 and the second device 45. That is, the devices are coupled to the endpoints 62 of the flexible wire assembly 20. Although FIG. 5 illustrates a number of possible embodiments of a flexible wiring system, the scope of the invention should not be limited to such embodiments as various additional permutations of connections are also possible. For example, device 25 may be coupled to one side of the flexible wire assembly 20, while the second device may be coupled to an end of the flexible wire assembly 20. Additionally, one or more devices may be coupled along the length of the flexible wire assembly 20. In this manner, multiple devices could easily be connected in a “daisy chained” manner along the length of the flexible wire assembly 20.

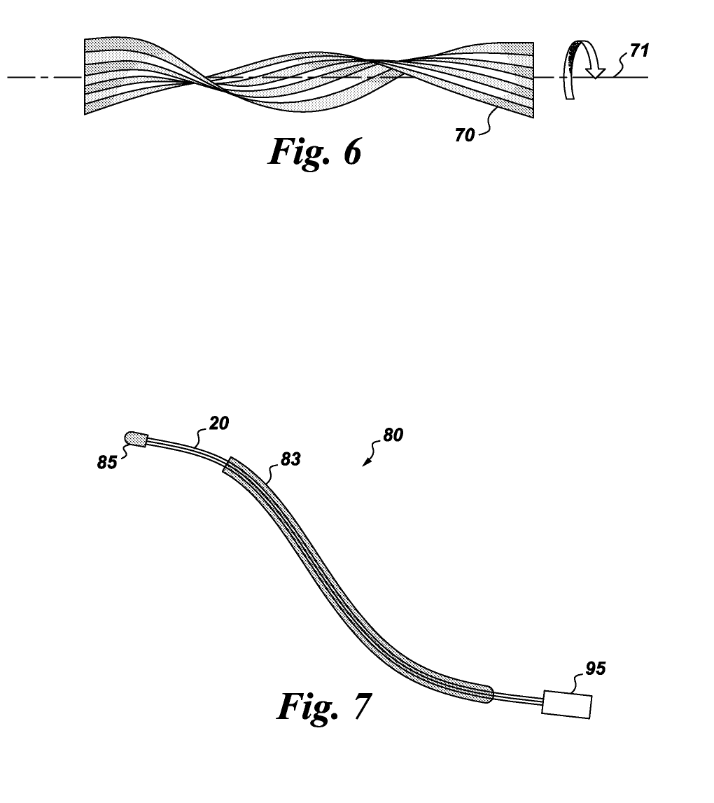

FIG. 6 illustrates a flexible wire assembly in a twisted configuration according to one embodiment of the invention. The flexible wire assembly 70 is substantially similar to the flexible wire assembly 20. However, after the flexible wire assembly 70 is formed it is twisted about a longitudinal axis 71. For example, one end of the flexible wire assembly 70 may be twisted in a first rotational (e.g. clockwise) direction around the longitudinal axis 70, while the other end is held stationary. Alternatively, one end of the flexible wire assembly 70 may be twisted in a first rotational (e.g., clockwise) direction, while the other end is twisted in a second opposite rotational (e.g., counter-clockwise) direction. By twisting the flexible wire assembly 70 in such a manner, it is possible to easily reduce electromagnetic interference in the conductors without compromising form-factor nor requiring any additional shielding or insulation. As with the flexible wire assembly 20, the flexible wire assembly 70 may be coated with an insulator prior to being twisted. However, this again is much more simple from a materials and process perspective than having to coat each individual conductor before twisting or requiring one conductor to be wrapped around another before coating.

FIG. 7 illustrates a flexible wire assembly in the form of a flexible instrument assembly 80, in accordance with a further embodiment of the invention. Flexible instrument assembly 80 includes the flexible wire assembly 20 as previously described coupled to at least a first device 85 and a second device 95 and at least partially surrounded by a sheath 83. Flexible instrument assembly 80 may be manufactured according to the previously described methods. Moreover, the flexible wire assembly 20 may be inserted through the sheath 83 prior to the one or more devices being connected, or the sheath 83 may be wrapped around the flexible wire assembly 20 after one more devices are connected. In one embodiment, the flexible instrument assembly 80 represents a catheter that may be utilized in a variety of imaging, ablation or other medical procedures. In such an embodiment, the sheath 83 and the flexible wire assembly 20 may be made from or coated with biocompatible materials. In another embodiment, the flexible instrument assembly 80 may represent an industrial inspection device for use in a variety of imaging or repair procedures, for example. In such an embodiment, the sheath 83 and the flexible wire assembly 20 may be made from or coated with a high temperature materials such as polyimides and flexible glass, for example. Additionally, in certain embodiments, the length of the flexible wire assembly 20 can be easily scaled up to and over multiple meter-long lengths.

In one embodiment, device 85 may represent an array of ultrasonic transducers that generate high frequency energy. The energy may be used to burn a target area or to generate and detect reflected sound waves for imaging. The reflected sound waves may be processed by one or more signal processors or microprocessors coupled to device 85. The processors may be co-located with the device 85 on the treatment end of the assembly or the processors may be part of device 95. Device 95 may further include one or more microprocessors, printed circuit boards, or other electronic or structural devices to further process the reflected sound waves to form an image.

In yet another embodiment, device 85 of the flexible instrument assembly 80 may include one or more mechanical tools to perform an action such as grasping, pinching or cutting, or for performing industrial inspection procedures. For example, electronic signals may be transmitted from device 95 at a proximal end along the flexible wire assembly 20 to a device 85 at a distal end where the device 85 would include the mechanical implements necessary to perform the intended application. Device 85 may further include one or more micro-motors coupled to the implements or additionally provided to induce motion. Alternatively, device 85 may include an imaging device such as a camera and an electro-optical converter to convert optical signals received by the camera to electrical signals. The electrical signals are then transmitted via the flexible wire assembly 20 to device 95 for further processing.

Thus, the various embodiments of the flexible wire assemblies, flexible wire systems and flexible instrument assemblies described herein provide long, fine-pitched wiring solutions that solve an existing need. Although prior efforts have attempted to make fine-pitch interconnects, no one has been able to make long length fine-pitch wiring having reduced labor and material costs and easy manufacturability as the embodiments described herein.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method of making a flexible wire assembly comprising:
forming a laminate stack of alternating parallel layers of conducting material and insulating material, wherein the layers of conducting material and the layers of insulating material are substantially planar, and wherein the laminate stack is defined by a stack width (SW) dimension, a stack length (SL) dimension, and a stack height (SH) dimension, and wherein the stack width (SW) and the stack length (SL) dimensions are coplanar with the conducting and insulating layers and the stack height (SH) dimension is measured transversely across the conducting and insulating layers; and
singulating the laminate stack into at least one long flexible wire assembly having alternating conductors and insulators by dicing the laminate stack at a singulation pitch along a longitudinal axis aligned with the stack length (SL) such that the resulting flexible wire assembly comprises a wire length (wl), a wire width (ww) and a wire height (wh), wherein the wire width (ww) corresponds to the stack height (SH), the wire height (wh) corresponds to the singulation pitch, and the wire length (wl) corresponds to the stack length (SL) and is one or more orders of magnitude greater than the wire width (ww) and the wire height (wh).

2. The method of claim 1, wherein singulating the laminate stack into at least one long flexible wire assembly having alternating conductors and insulators comprises singulating the laminate stack such that at least a plurality of the conductors and insulators comprise a quadrilateral cross-section.

3. The method of claim 1, wherein each conductor corresponds to a separate layer of conducting material in the laminate stack and each insulator corresponds to a separate layer of insulating material in the laminate stack.

4. The method of claim 1, wherein laminating further comprises:
adhering each layer of conducting material to at least one layer of insulating material; and
applying heat and pressure to form the laminate stack.

5. The method of claim 1, wherein each of the layers of conducting material comprises a first thickness and each of the layers of insulating material comprises a second thickness, and wherein the first thickness and second thickness are different.

6. The method of claim 1, wherein at least one layer of insulating material comprises a dielectric.

7. The method of claim 1, wherein none of the layers of conducting material within the flexible laminate stack is patterned.

8. The method of claim 1, further comprising providing an electrically isolating material across the layers of conducting material and the layers of insulating material.

9. The method of claim 8, wherein providing an electrically isolating material across the layers of conducting material and the layers of insulating material comprises coating the flexible wire assembly in the electrically isolating material.

10. The method of claim 1, further comprising twisting the flexible wire assembly with respect to itself along the longitudinal axis.

11. The method of claim 1, wherein singulating comprises:
mechanically dicing the laminate stack along the longitudinal axis.

12. The method of claim 1, further comprising coupling the at least one flexible wire assembly to a device or substrate having a bond pad pitch wherein a spacing between the conductors of the flexible wire assembly align with the bond pad pitch.

13. The method of claim 1, further comprising coupling the at least one flexible wire assembly to a first device at one end of the flexible wire assembly and to a second device at a second end of the flexible wire assembly.

14. The method of claim 13, wherein the first device is coupled to the first end of the flexible wire assembly on a first side and the second device is coupled to the second end of the flexible wire assembly on the first side.

15. The method of claim 13, wherein the first device is coupled to the first end of the flexible wire assembly on a first side and the second device is coupled to the second end of the flexible wire assembly on a second side.

16. The method of claim 13, wherein the first device is coupled to the first end of the flexible wire assembly at a first end point and the second device is coupled to the second end of the flexible wire assembly at a second end point.

17. A flexible wiring system comprising:
a flexible wire assembly comprising a plurality of elongated conductors and insulators each having a quadrilateral cross section and alternatingly laminated together, the flexible wire assembly having a wire width (ww) measured across the conductor and insulators, a wire height (wh) equivalent to the height of the conductors and insulators, and a wire length (wl) which is measured in a longitudinal direction orthogonal to the wire width and the wire height, wherein the wire length is one or more orders of magnitude greater than the wire width (ww) and the wire height (wh); and
a first device comprising a plurality of bond pads spaced to define a bond pad pitch, wherein the flexible wire assembly is coupled to the first device at the bond pads such that spacing of the conductor conductors is matched to the bond pad pitch.

18. The system of claim 17, wherein at least one layer of insulating material comprises a dielectric.

19. The system of claim 17, further comprising an electrically isolating material covering the layers of conducting material and the layers of insulating material.

20. The system of claim 17, wherein the wire length is multiple orders of magnitude greater than the wire width (ww) and the wire height (wh).

21. The system of claim 17, wherein the flexible wire assembly is twisted with respect to itself along the longitudinal axis.

22. The system of claim 17, further comprising a second device coupled to the flexible wire assembly, wherein the flexible wire assembly is coupled to the first device at a first end of the flexible wire assembly and the flexible wire assembly is coupled to the second device at a second end of the flexible wire assembly.

23. The system of claim 22, wherein the first device is coupled to the flexible wire assembly on a first side and the second device is coupled to the flexible wire assembly on the first side.

24. The system of claim 22, wherein the first device is coupled to the flexible wire assembly on a first side and the second device is coupled to the flexible wire assembly on a second side.

25. The system of claim 17, wherein the system comprises a catheter.

26. The system of claim 17, wherein the system comprises an industrial inspection device.
